(19) United States
(12) Patent Application Publication
(10) Pub. No.: US 2016/0277500 A1
(43) Pub. Date: Sep. 22, 2016

(54) EMBEDDED EXECUTABLE DATA FOR CROSS NETWORK TRANSFER

(71) Applicant: LinkedIn Corporation, Mountain View, CA (US)

(72) Inventors: Donald Ellis Flood, Oakland, CA (US); Russell Monroe Glass, Belmont, CA (US); Christopher Lawrence Mann, Fairfax, CA (US)

(21) Appl. No.: 15/157,616

(22) Filed: May 18, 2016

Related U.S. Application Data
(63) Continuation of application No. 14/218,413, filed on Mar. 18, 2014.

(51) Int. Cl. H04L 29/08; G06Q 30/02; H04L 29/06

(52) U.S. Cl. CPC H04L 67/1097; H04L 67/42; H04L 67/02; G06Q 30/0277; G06Q 30/0251

(57) ABSTRACT

A device identifier is associated with a client device that is used to interact with multiple remote content data sources over one or more computer networks. Interaction data is received from a client device based on executable code that is embedded in content requested by the client device. The interaction data describes interactions between the client device and the remote content data sources. The interaction data is aggregated based on the device identifier being associated with different interaction data. The aggregated interaction data is analyzed to produce analyzed data describing the interactions between the client device and the remote content data sources.

### CROSS-REFERENCE TO RELATED APPLICATIONS, BENEFIT CLAIM

This application is a Continuation of U.S. patent application Ser. No. 14/218,413, filed Mar. 18, 2014, the entire contents of which is hereby incorporated by reference for all purposes as if fully set forth herein. The applicants hereby rescind any disclaimer of claim scope in the parent application or the prosecution history thereof and advise the USPTO that the claims in this application may be broader than any claim in the parent application.

### TECHNICAL FIELD

This application relates to retrieving and processing electronic data and, more particularly to, retrieving, over a network, from a client device, interaction data that pertains to remote content data sources and that is based on executable code that is embedded in requested content from the remote content data sources. SUGGESTED GROUP ART UNIT: 2447; SUGGESTED CLASSIFICATION: 709/201.

### BRIEF DESCRIPTION OF DRAWINGS

FIG. 1 is a high-level block diagram illustrating an embodiment of an environment for a data processing system.

FIG. 2 is an interaction diagram of a method for mapping a data processing platform identifier to one or more data source-specific identifiers according to an embodiment.

FIGS. 3A-B are an interaction diagram of a method for associating a computing device with a segment in a nurture flow according to an embodiment.

FIG. 4 is a high-level block diagram illustrating an example computer for implementing the entities shown in FIG. 1.

FIG. 5 is a high-level block diagram illustrating a detailed view of modules within a data processing platform according to one embodiment.

FIG. 6 is a flowchart illustrating a process for mapping a data processing platform identifier to one or more data source-specific identifiers according to an embodiment.

FIG. 7 is a flowchart illustrating a process for updating segment membership data according to an embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

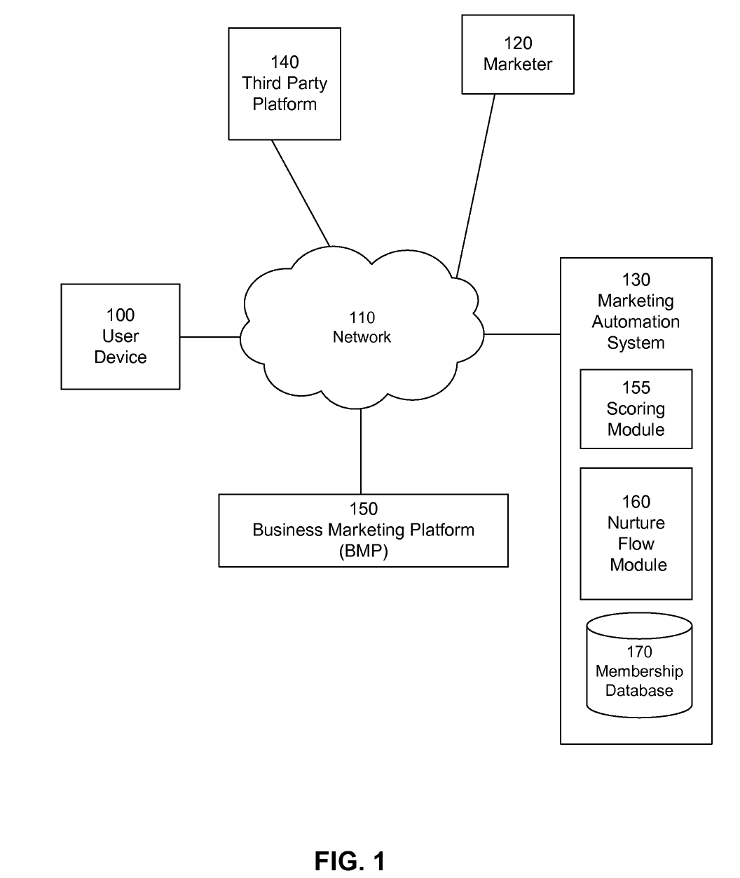

FIG. 1 is a high-level block diagram illustrating an embodiment of an environment of an audience targeting system. The environment includes a user device 100 connected by a network 110 to a vendor 120, a targeting automation system (TAS) 130, a third party platform 140, and a business promoting platform (BMP) 150. Here only one user device 100, vendor 120, TAS 130, third party platform 140, and BMP 150 are illustrated but there may be multiple instances of each of these entities. For example, there may be thousands or millions of user devices 100 and vendors 120, in communication with multiple third party platforms 140, TASs 130 and BMPs 150. Additionally, in some embodiments, the TAS 130 and the BMP 150 may be the same entity. Similarly, in some embodiments, one or more functions performed by the TAS 130 may be performed by the BMP 150.

The network 110 provides a communication infrastructure between the user devices 100 and the media sources 120. The network 110 is typically the Internet, but may be any network, including but not limited to a Local Area Network (LAN), a Metropolitan Area Network (MAN), a Wide Area Network (WAN), a mobile wired or wireless network, a private network, or a virtual private network.

The user devices 100 are computing devices that execute computer program modules—e.g., web browsers or other client applications—which allow a user to access and view content from other systems on the network 110. Additionally, a user device 100 may execute computer program modules (e.g., a widget) that cause the user device to perform one or more operations in-browser. A user device 100 might be, for example, a personal computer, a tablet computer, a smart phone, a laptop computer, or other type of network-capable device such as a networked television or set-top box.

The vendor 120 includes one or more computer servers that provide content to the user devices 100. The vendor 120 may sell a product and/or service to users of the user devices 100 via, for example, one or more web pages. The vendor 120 has an associated target audience. A target audience is a specific group of people (e.g., users) within a target market to which a message for a product and/or service is aimed. In some embodiments, the vendor 120 is able to receive user information identifying a user visiting its website (e.g., by allowing a visiting user to create an online account, sign up for a newsletter, etc.). User information is information that identifies the user to the vendor 120, and may also describe other attributes of the user. User information may include, for example, a user name, address, email address, telephone number, a user device identifier, interests of the user, etc. In some embodiments, the vendor 120 may send emails to known users. For example, the vendor 120 may send an advertisement for a particular product or service to a user who has signed up for its newsletter.

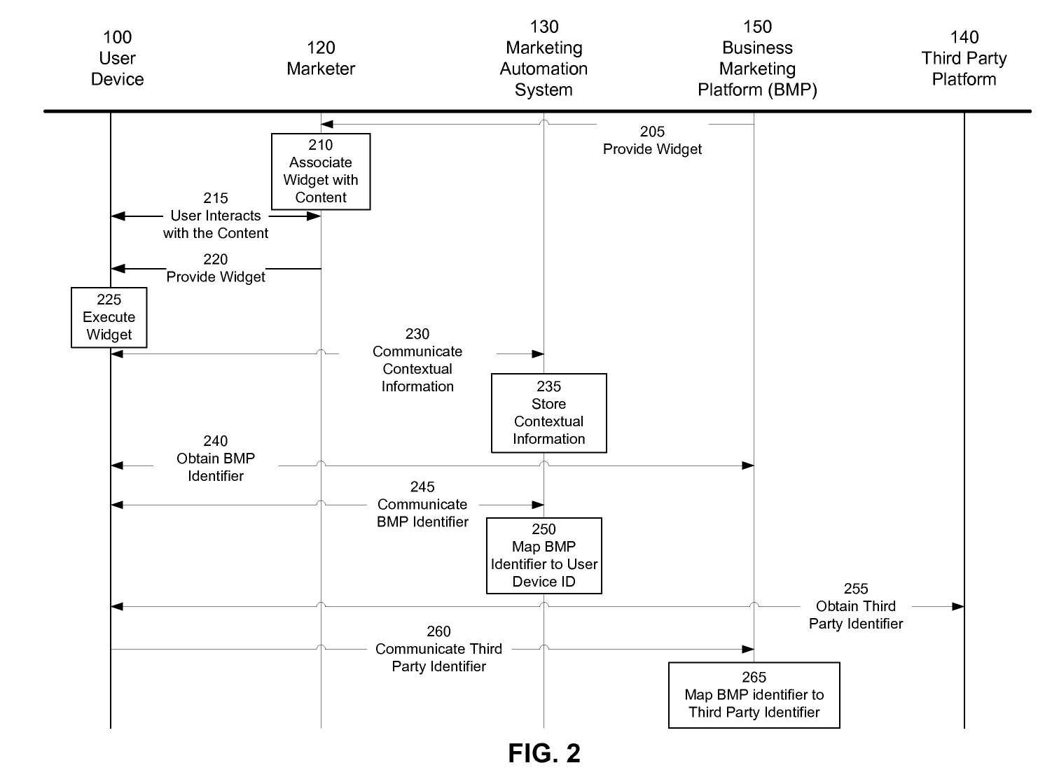

In some embodiments, the vendor 120 associates a widget with vendor content. Vendor content may be content associated with the vendor 120, some other entity, or some combination thereof. Vendor content may include, for example, an advertisement for a product and/or service, media relating to the vendor 120, media relating to some other entity, or some combination thereof. Vendor content is content provided by the vendor 120. Vendor content may be provided to a user device 100 via, for example, one or more web pages associated with the vendor 120, an app executing on the user device 100, or some combination thereof. The vendor 120 associates the widget with vendor content, such that the widget is provided to user devices 100 interacting with the vendor content (e.g., via a web page and/or a software application (app) operating on the user device 100). The widget is code or instructions (e.g., JAVASCRIPT®, etc.), that causes the user device 100 to perform various operations when the user device 100 visits one of the web pages (as discussed in detail below with respect to FIG. 2). The operations may be, for example, to provide contextual information to one or more entities (e.g., the TAS 130), retrieve various identifiers for the user device 100, provide retrieved identifiers to various entities (e.g., the TAS 130, the BMP 150, etc.), or some combination thereof. Additionally, one or more of the operations may be performed by a browser of the user device 100. In some embodiments, some or all of the operations are performed in a manner transparent (i.e., not apparent) to a user of the user device 100. In some embodiments, the widget is received by the vendor 120 from the BMP 150, the TAS 130, or some other entity.

The vendor 120 creates one or more segments that are associated with a particular nurture flow. A nurture flow is a targeting plan that is divided into progressive segments (e.g., steps) that funnel a user toward performing a particular action (e.g., perform a conversion on a website associated with the vendor 120). A segment is associated with one or more parameters that influence how entities (e.g., the third party platform 140) interact with a user device 100 used by a user associated with that segment. For example, a parameter may be to provide a particular advertisement when a request for an advertisement is received from the user device 100 in the associated segment. In some embodiments, the vendor 120 selects the parameters when creating the segments. In alternate embodiments, other entities (e.g., the TAS 130) may select and/or update one or more parameters associated with segments.

Each segment is associated with a measure of influence of the user associated with the user device 100. A measure of influence is indicative of how likely the user is to perform an intended action (e.g., purchase a product/service). A measure of influence may be, for example, a lead score, a measure of engagement of the user, or some other measure that is indicative of how likely the user is to perform the intended action. For example, each segment may be associated with one or more lead scores that measure the relative probability of a user to become a customer. In general, when a user is first associated with a nurture flow they are associated with an entry segment. An entry segment is associated with users entering the nurture flow. As discussed below with reference to the TAS 130, as the measures of influence of those users increase, they are assigned to progressive levels of segments that funnel the users toward performing a particular action. In some embodiments, the vendor 120 establishes one or more conditions that if satisfied, affect a user's measure of influence. For example, satisfying the conditions may increase the lead score associated with the user. In alternate embodiments, other entities (e.g., the TAS 130, the BMP 150, etc.) may specify one or more of the conditions. The vendor 120 provides segment information describing segments and their associated conditions to the TAS 130. In some embodiments, the vendor 120 may also selectively update one or more segments that were previously provided to the TAS 130.

The TAS 130 manages nurture flows associated with an associated vendor 120. The TAS 130 comprises a scoring module 155, a nurture flow module 160, and a membership database 170, in one embodiment. In one embodiment these entities are software application modules executing on the TAS 130.

The scoring module 155 determines a measure of influence of a user associated with a user device 100 based in part on whether condition(s) associated with a segment have been satisfied. Additionally, the scoring module 155 updates the measure of influence (e.g., a lead score) for the user device 100 using information received from the vendor 120, the BMP 150, the third party platform 140, or some combination thereof.

The nurture flow module 160 maps user devices 100 (and their associated users) to segments within nurture flows based on the measures of influence. Specifically, the nurture flow module 160 maps an identifier (e.g., BMP identifier) associated with the user device 100 and its associated user to a segment. In some embodiments, user devices 100 and their associated users are mapped to an entry segment when they are first associated with a nurture flow. In some embodiments, the nurture flow module 160 may associate a user device 100 and its associated user to some other segment in the nurture flow based on the contextual information received from the vendor 120. The mapping between user devices 100 (and their associated users) and segments is part of segment membership data. Segment membership data controls, in part, how a third party platform 140 interacts with a user device 100. Segment membership data includes, for example, one or more segments (including associated parameters), one or more identifiers associated with a user device 100 (e.g., a user device identifier, a TAS identifier, a BMP identifier, a third party identifier, or some combination thereof), a mapping of a segment to one or more identifiers associated with a user device 100, or some combination thereof. The nurture flow module 160 passes the segment membership data to the membership database 170.

The nurture flow module 160 updates segment membership data for user devices 100 and their associated users based on changes in their respective measures of influence. For example, an updated measure of influence may cause the nurture flow module 160 to map a user device 100 initially associated with an entry segment to a different segment in the nurture flow. As the measure of influence increases, the user device 100 (and its associated user) may be assigned to segments that progressively funnel the users toward performing a particular action. A user device 100 and its associated user are only mapped to a single segment in a nurture flow at any given time. However, a user device 100 and its associated user may concurrently be mapped to different segments in other nurture flows. The nurture flow module 160 provides segment information to the BMP 150.

The nurture flow module 160 may adjust parameters associated with segments based on data received from other entities (e.g., the BMP 150 and the vendor 120). The nurture flow module 160 may specify one or more parameters associated with a particular segment. For example, the nurture flow module 160 may select a particular advertisement, and specify a parameter associated with a segment to cause third party platforms 140 to present the selected advertisement to user devices 100 associated with that segment. In some embodiments, the advertisement is selected by determining effectiveness for each of a plurality of advertisements using the received data, and selecting the most effective advertisement. In some embodiments, the nurture flow module 160 automatically modifies parameters based on data received from the BMP 150 describing user device 100 interactions with one or more third party platforms 140. Additionally, in some embodiments, the nurture flow module 160 may adjust conditions (e.g., changing the number of times an ad is shown to a user to satisfy the condition) associated with one or more segments.

The membership database 170 stores conditions associated with one or more segments and segment information associated with one or more user devices 100 and their associated users. Segment information may include, for example, segment membership data, one or more conditions associated with a segment, contextual information associated with the user device 100, or some combination thereof.

The third party platform 140 is a computer platform that stores segment information on a per user basis and/or per user device basis. The third party platform 140 uses the segment membership data to provide a user of the user device 100 with advertising selected based on the user's segment in a particular nurture flow for a product/service. A third party platform 140 may be, for example, an ad exchange, a social networking system, a content management system (e.g., a system used to run a blog, shopping website, news website, etc.), or some other computer platform that can track data on a per user basis. A third party identifier identifies an associated user device 100 and/or user associated with the user device 100 to the third party platform 140. Additionally, each third party platform 140 has its own set of unique third party identifiers for the user device 100 (and its associated user).

The third party platform 140 interacts with a plurality of user devices 100 based in part on segment membership data associated with the user devices 100 and their associated users. The third party platform 140 receives segment membership data from the BMP 150, including for example, a mapping of a segment to the third party identifier used by the third party platform 140 to identify the user device 100 and the user associated with the user device 100, and one or more parameters associated with the segment.

The third party platform 140 tracks interactions of user devices 100 with the third party platform 140. The interactions are stored with the respective third party identifier as interaction data. Interaction data is information that describes interactions between user devices 100 and a third party platform 140. Interaction data includes for example, third party identifiers and information describing associated interactions, like for example, number of times a particular advertisement is sent to a user device 100 for presentation to the user, number of times a particular web page is sent to a user device 100 for presentation to the user, user interactions with a particular advertisement. The third party platform 140 provides the interaction data that is associated with users of the user devices 100 who are also associated with segment information to the BMP 150.

The BMP 150 maps a BMP identifier to one or more third party identifiers. A BMP identifier is information that uniquely identifies a particular user device 100 to the BMP 150. Thus, the BMP 150 is able to map a single user device 100 (and associated user) to multiple third party platforms 140. Further, the mapping of the BMP identifier to third party identifiers associated with various third party platforms 140 allows the BMP 150 to aggregate and analyze interaction data received from the multiple third party platforms 140 on a per user basis.

In one embodiment, the BMP 150 provides the widget described above to the vendor 120 who then may provide it to the user devices 100. The widget causes the user device 100 to obtain identifiers associated with the user device 100 from itself (e.g., a device identifier), the BMP 150, and one or more third party platforms 140, and provide some (or all) of those identifiers to the TAS 130 and the BMP 150. In some embodiments, the BMP 150 creates the widget. Alternatively, the BMP 150 may receive the widget from some other entity.

The BMP 150 maintains segment membership data received from the TAS 130 for one or more of the user devices 100. The BMP 150 associates the segment membership data with the appropriate third party identifiers, and provides portions of the segment membership data (e.g., third party identifiers, segments, and mappings between the third party identifiers and the segments) to the third party platforms 140.

The BMP 150 performs analytics on interaction data received from one or more of the third party platforms 140. The BMP 150 performs the analytics on the interaction data to generate analyzed data which the TAS 130 may use to adjust a user's measure of influence. In some embodiments, the BMP 150 and/or some other entity (e.g., vendor 120) may also use the analyzed data. Additionally, in some embodiments, the analyzed data may be used to determine an effectiveness of conditions and/or parameters associated with a segment, modify conditions and/or parameters associated with a segment, identify which third party platforms 130 users of user devices 100 tend to interact with, determine whether to lower or raise a per impression bid per user (and ad campaign), etc. For example, the BMP 150 may group interaction data received from different third party platforms 140, and perform analytics on a per user basis and/or a per user device 100 basis. As noted above, the BMP 150 maintains a mapping for each user device 100 of a BMP identifier to one or more third party platform identifiers. Accordingly, the BMP 150 is able to group, by BMP identifier, interaction data received from various third party platforms 140—and analyze those results. This grouping aggregates a single user device 100's (and its associated user) activities across all of the third party platforms 140. For example, the BMP 150 may be able to determine the number of times a particular user viewed a particular advertisement during interactions with different third party platforms 140. The BMP 150 provides the analyzed data to the TAS 130 and/or some other entity.

The BMP 150 has the ability to coordinate how (via, e.g., segment membership data) third party platforms 140 interact with the user device 100 (and it associated user). This allows a TAS 130 to more effectively funnel a user towards performing a particular action. The ability of the BMP 150 to map a user device 100, via a BMP identifier, to multiple third party identifiers allows it to push segment membership data to third party platforms 140, analyze interaction data received from the third party platforms 140, and provide the analyzed data to the TAS 130 on a per-user device and/or a per user basis. Thus, allowing a TAS 130 to control and coordinate what advertising is presented to a user such that the user is funneled toward performing a particular action (e.g., purchase of a product).

FIG. 2 is an interaction diagram showing the mapping process in more detail, specifically, FIG. 2 is an interaction diagram of one embodiment of a method for mapping a BMP identifier to one or more third party identifiers. In various embodiments, the method may include different and/or additional steps than those described in conjunction with FIG. 2. Additionally, in some embodiments, the steps may be performed in a different order than described in conjunction with FIG. 2.

The BMP 150 provides 205 a BMP widget (“widget”) to the vendor 120. The widget is then associated 210 with vendor content. Vendor content may be provided to a user device 100 via, for example, one or more web pages, an app executing on the user device 100, or some combination thereof. For example, the vendor 120 may associate the widget with a web page associated with the vendor 120 and/or content that the user device 100 may interact with via an app. The vendor 120 selects vendor content to be associated with the widget. In some embodiments, the vendor 120 associates the widget with the selected vendor content. Alternatively, in some embodiments, the widget may include code that automatically associates the widget with the selected vendor content.

A user, via a user device 100, interacts 215 with a vendor 120's vendor content that is associated with the widget. For example, the user device 100 may request vendor content from a website associated with the vendor 120. Alternatively, the user device 100 may interact with vendor content via an app installed on the user device 100. In some embodiments, the widget is sent to the user device 100 as part of the requested vendor content (e.g., requested web page). Alternatively, the requested vendor content may include a function that causes the user device 100 to request the widget from another source.

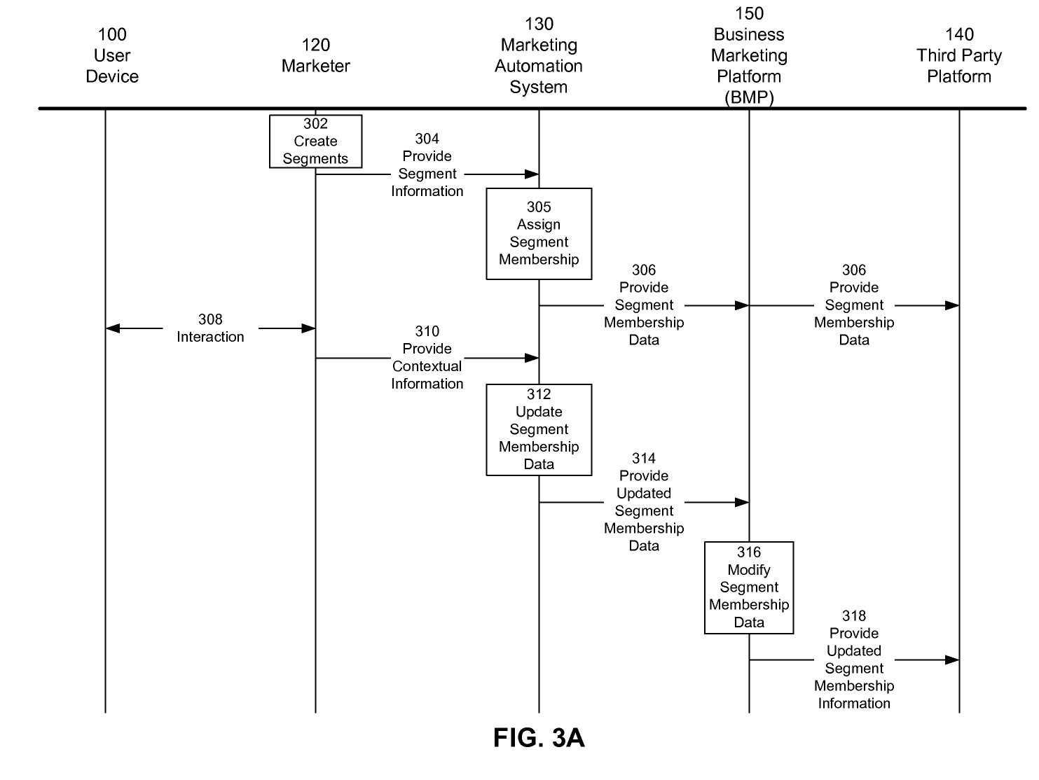

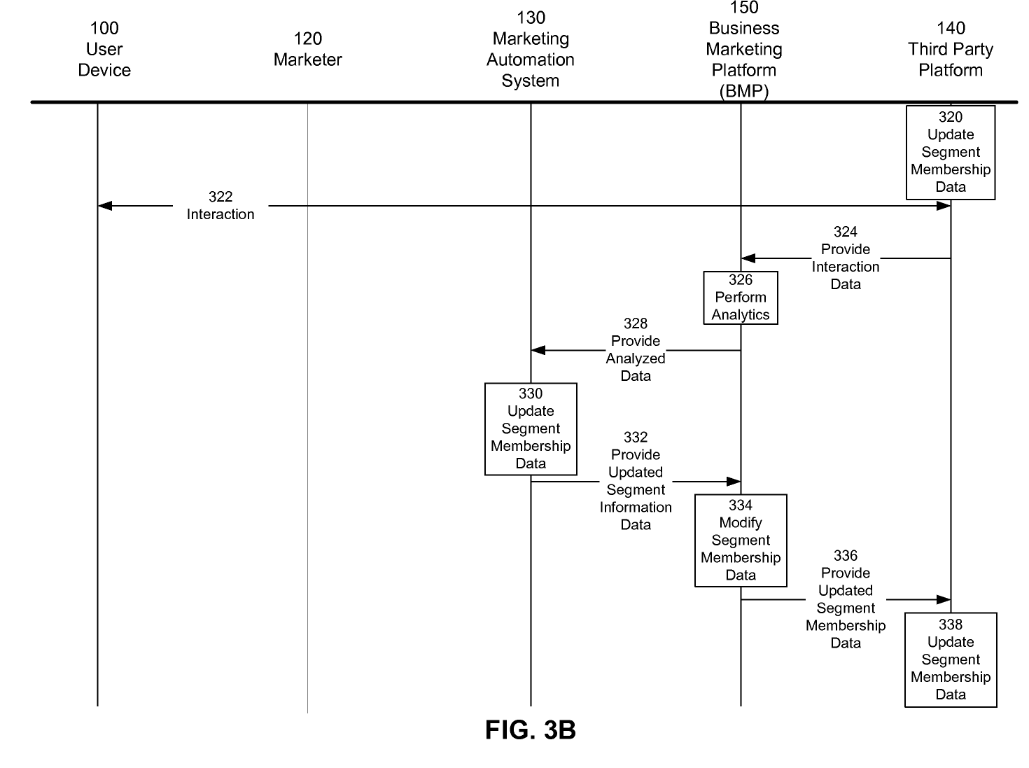

The user device 100 executes 225 the widget, causing the user device 100 to perform (in browser) steps 230, 240, 245, 255, and 260. The widget retrieves contextual information describing interactions between the user device 100 and the vendor 120, and instructs the browser of the user device 100 to communicate 230 the contextual information to the TAS 130. The contextual information describes interactions between the user device 100 and the vendor 120, such as, e.g., signing up for a mailing list, viewing a web page, performing a conversion, etc. Additionally, in some embodiments, the contextual information includes a user device identifier (e.g., a device identifier) that identifies the user device 100. The TAS 130 stores 235 the contextual information in the membership database 170. As described below with reference to FIG. 3, in some embodiments the TAS 130 may use the contextual information to select a segment and nurture flow to associate with the user device 100. The TAS 130 attempts to retrieve a TAS identifier using the contextual information. If a TAS identifier is retrieved, the TAS 130 associates the contextual information with the retrieved TAS identifier. If a TAS identifier is not retrieved (e.g., if the user device 100 has not interacted with the TAS 130 before) the TAS 130 generates a TAS identifier for the user device 100 based on the receipt of contextual information including a new user device identifier. The TAS identifier may then use the TAS identifier to identify the user device 100.

The widget also causes the user device 100 to obtain 240 a BMP identifier associated with the user device 100 from the BMP 150. In some embodiments, as part of obtaining the BMP identifier, the user device 100 may provide a user device identifier, a TAS identifier, or some other information identifying the user device 100 to the BMP 150. The BMP 150 may utilize some, or all of, the received identifying information to generate a BMP identifier (e.g., hashing a user device identifier). The BMP 150 provides the BMP identifier to the user device 100.

After receipt of the BMP identifier, the widget causes the user device 100 to communicate 245 the BMP identifier to the TAS 130. Additionally, the communication may include other information in association with the BMP identifier identifying the user device 100 to the TAS 130 (e.g., a user device identifier or a TAS identifier). The TAS maps 250 the BMP identifier to a TAS identifier and/or user device identifier.

After communicating 245 the BMP identifier to the to the TAS 130, the widget causes the user device 100 to obtain 255 a third party identifier from a third party platform 140. In some embodiments, the widget causes the user device 100 to obtain third party identifiers from a plurality of third party platforms 140, where one or more of the third party identifiers may be unique to its associated third party platform 140. After receiving the one or more third party identifiers, the user device 100 then communicates 260 the obtained one or more third party identifiers to the BMP 150. In addition to the third party identifier, the communication may include a BMP identifier.

The BMP 150 maps 265 the BMP identifier to the obtained one or more third party identifiers. In some embodiments, the BMP 150 may additionally map other identifiers (e.g., user device identifier or TAS identifier) for the user device 100 to the BMP identifier. The mapping of a BMP identifier to a plurality of third party identifiers allows the BMP to aggregate and analyze interaction data from multiple third party platforms 140 on a per user basis and/or user device 100 bases.

Turning now to a discussion of creating and updating segment membership, FIGS. 3A-B are an interaction diagram of a method for associating a user device 100 with a segment in a nurture flow according to an embodiment. In various embodiments, the method may include different and/or additional steps than those described in conjunction with FIGS. 3A-B. Additionally, in some embodiments, the steps may be performed in a different order than described in conjunction with FIGS. 3A-B. In this embodiment, the mapping described above with reference to FIG. 2 has already occurred.

The vendor 120 creates 302 segments associated with a particular nurture flow. Each segment in the nurture flow is associated with a particular measure of influence between the user and the nurture flow. The vendor 120 determines one or more parameters for each segment that influence how the vendor 120 and one or more third party platforms 140 interact with a user device 100 associated with that segment. A parameter may be, for example, a particular advertisement, targeting criteria used to select an advertisement, sending a particular message (e.g., email, SMS, etc.) to the user device 100, or some combination thereof.

Additionally, each created segment is associated with a measure of influence that determines whether a user device 100 and its associated user are mapped to a particular segment. The measures of influence are determined in part, by satisfying conditions associated with each segment. Conditions may include, for example, presenting a web page associated with the vendor 120 to the user via a user device 100, a user interacting with the vendor 120's website, a user interacting with a third party platform 140, providing, by a third party platform 140, an advertisement to the user device 100 for presentation to the user, the vendor 120 sending a communication (e.g., email) to the user device 100, a period of time a user device 100 has been associated with a particular segment, a professional title associated with the user, a company that employs the user, a user attending an event (e.g., user attends a tradeshow), or some combination thereof.

The vendor 120 provides 304 segment information to the TAS 130. The TAS 130 assigns (associates) 305 the user device 100 and its associated user with a segment. Note, it is understood that a user device 100 and/or a user may be associated with a segment. The TAS 130 may assign a user device 100 to an entry segment or some other segment in the nurture flow. For example, a user who viewed a web page associated with the vendor 120 may be associated with an entry segment, and a user who signed up for the vendor 120's email newsletter might be assigned to some other segment further along in the nurture flow.

The TAS 130 stores the received segment information in its membership database 170. Additionally, in some embodiments, the TAS 130 may adjust one or more conditions and/or parameters associated with the segments. Additionally, in some embodiments, the TAS 130 may create and/or delete segments from a particular nurture flow.

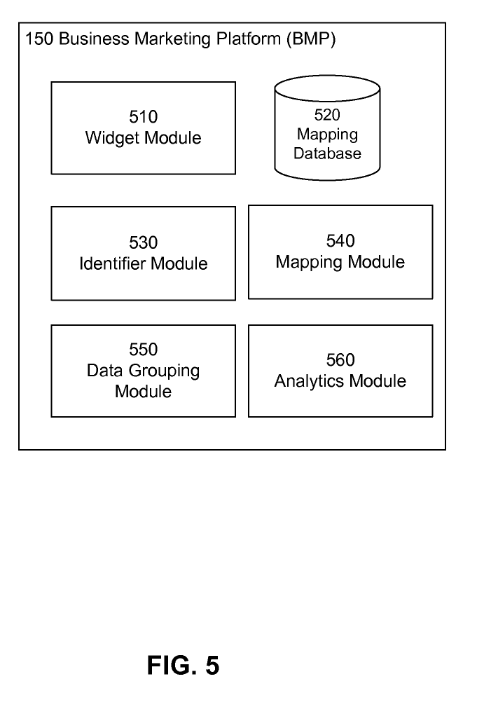

Segment membership data is then provided 306 to the BMP 150 and the third party platforms 140. The TAS 130 provides segment membership data to the BMP 150. For example, the TAS 130 provides mappings of one or more identifiers associated with the user device 100 to a segment, and one or more parameters (e.g., targeting criteria used to select an advertisement) associated with the segment. The one or more identifiers provided by the TAS 130 may be, for example, a user device identifier, a TAS identifier, a BMP identifier, or some combination thereof. The BMP 150 modifies the segment membership data to include third party identifiers associated with the user device 100 for one or more third party platforms 140. As described below with respect to FIG. 5, the BMP 150 stores the modified membership data in a mapping database. The BMP 150 provides 306 a portion of the segment membership data to the third party platform 140. For example, the BMP 150 provides a third party identifier associated with the user device 110, a mapping of the third party identifier to a segment, and one or more parameters associated with the segment to the associated third party platform 140. The third party platform 140 stores the received segment membership data. Thus, the segment membership data is ‘pushed’ from the TAS 130 to the BMP 150 who in turn pushes the segment membership data to the third party platforms 140. While FIGS. 3A-B show a single third party platform 140, there may be multiple third party platforms 140, and the BMP 150 may provide 306 some or all of the segment membership data to each of the third party platforms 140.

In step 308 there is an interaction between a user via, e.g., the user device 100, and the vendor 120. For example, the user device 100 may sign up for a newsletter on the vendor 120's web site, the vendor 120 may send an email to the user device 100, etc. Additionally, in some embodiments, the interaction may take place between the user and the vendor 120 via some other mechanism. For example, a user may telephonically purchase a product from the vendor 120. The vendor 120 provides 310 contextual information describing the interaction between the user device 100 and the vendor 120 to the TAS 130.

The TAS then updates 312 a portion of the segment membership data associated with the user device 100, based on the contextual information received from the vendor 120. In some embodiments, the TAS 130 uses a measure of influence (e.g., a lead score or range of lead scores) to measure a user's engagement in a particular nurture flow. The TAS 130 may adjust the measure of influence associated with the user based on the contextual information. For example, the TAS 130 may adjust the measure of influence if the contextual information indicates that one or more conditions associated with segments in the nurture flow are satisfied. Additionally, in some embodiments, the amount the measure of influence is adjusted depends on the type of interaction. For example, signing up for a newsletter on the vendor 120's website may be weighted higher than simply visiting the vendor 120's website. If the adjusted measure of influence falls within a range values associated with a different segment, the TAS 130 de-associates the user device 100 from its original segment and associates it with the segment associated with the adjusted measure of influence.

The TAS 130 provides 314 the updated segment membership data to the BMP 150. The updated segment data includes identification information for the user device 100 (and its associated user) and the updated segment membership data of the user device 100 (and its associated user).

The BMP 150 modifies 316 the segment membership data based on the updated segment membership data received from the TAS 130. For example, assuming the user device 100 is associated with a new segment, the BMP 150 would update the mapping database to reflect the new mapping of various identifiers for the user device 100 to the new segment. The BMP 150 provides 318 the updated segment membership data to the third party platform 130. For example, the BMP 150 provides a mapping of the third party identifier associated with the user device 100 to the new segment, and one or more parameters associated with the segment.

The third party platform 140 likewise updates 320 its segment membership data based on the updated segment membership data received from the BMP 150. For example, the third party platform 140 may update the mapping of the third party identifier to the new segment.

In step 322 the user device 100 interacts with the third party platform 140. For example, the user device 100 may request an advertisement from the third party platform 140. The third party platform 140 then selects an advertisement in accordance with the one or more parameters associated with the segment associated with the requesting user device 100. The third party platform 140 provides the selected advertisement to the user device 100. The third party platform 140 stores information describing interactions between the user device 100 and the third party platform 140 as interaction data.

The third party platform 140 provides 324 the interaction data to the BMP 150 for the user device 100. The interaction data includes interaction information and the associated third party identifier for the user device 100. In some embodiments, there may be a plurality of third party platforms 140 that are each providing interaction data to the BMP 150.

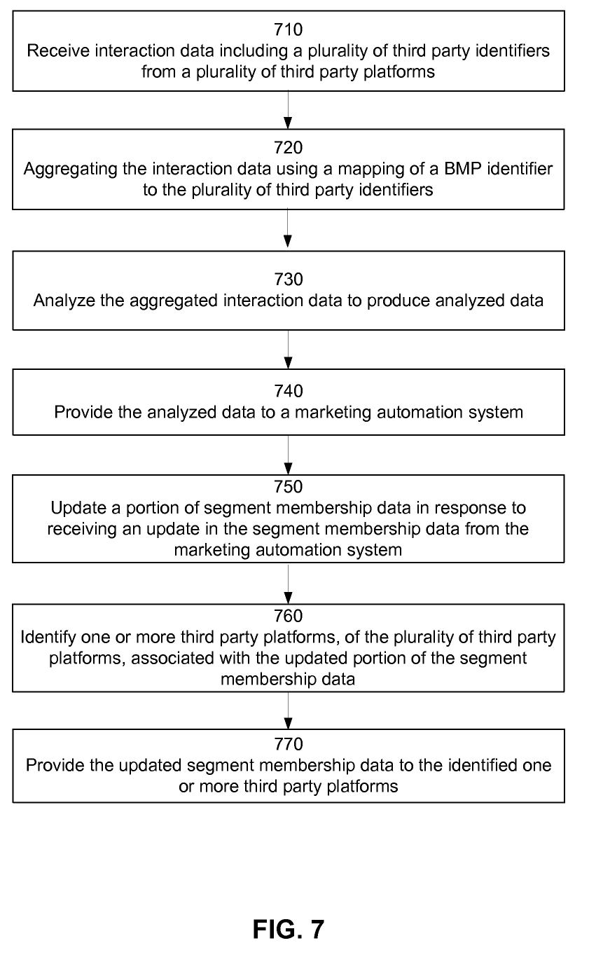

The BMP 150 groups the interaction data by BMP identifier (as discussed below with respect to FIGS. 5 and 7), and performs 326 analytics on the interaction data received from the third party platforms 140. The BMP 150 analyzes each grouping of data to produce analyzed data. For example, the BMP 150 may determine a number of times that a particular user device 100 was presented with a particular advertisement. The analyzed data may be organized by a single identifier like, for example, a BMP identifier. Thus, the BMP 150 is able to aggregate and analyze interaction data associated with a particular user device 100 (and associated user) that are received from different third party platforms 140. The BMP 150 provides 328 the analyzed data to the TAS 130.

The TAS 130 updates 330 segment membership data for the user device 100 based on the analyzed data. In some embodiments, the TAS 130 determines, for each user device 100, if the analyzed data satisfies one or more conditions for segments associated with the user device 100, and adjusts the measure of influence associated with the user device 100 accordingly. If the adjusted measure of influence falls within a range associated with a different segment, the TAS 130 de-associates a BMP identifier associated with the user device 100 with its original segment and associates it with the segment associated with the adjusted measure of influence. Similarly, in some embodiments, the TAS 130 may update segment membership data for a user associated with the user device 100 based on the analyzed data. Additionally, in some embodiments, the TAS 130 may update parameters associated with one or more segments based on the analyzed data. For example, the analyzed data may indicate that a particular advertisement is more effective than another advertisement for the same product. The TAS 130 may update one or more parameters associated with a segment such that the more effective advertisement is presented by the third party platform 140 in the future.

The TAS 130 then provides 332 the updated segment membership data to the BMP 150. Steps 334, 336, and 338, are performed in the similar manner to steps 316, 318, and 320, respectively. The updates to the segment membership data are pushed out to the BMP 150 and any third party platforms 140. Thus, enabling the third party platforms 140 to interact with the user devices 100 in accordance with the updated segment membership. This progressive updating of segment membership data funnels the user toward performing a particular function. The mapping of the BMP identifier to various third party identifiers, and the ability to push segment membership data to third party platforms 140 allows the BMP 150 to effectively influence how the third party platforms 140 interact with the user and the associated user device 100.

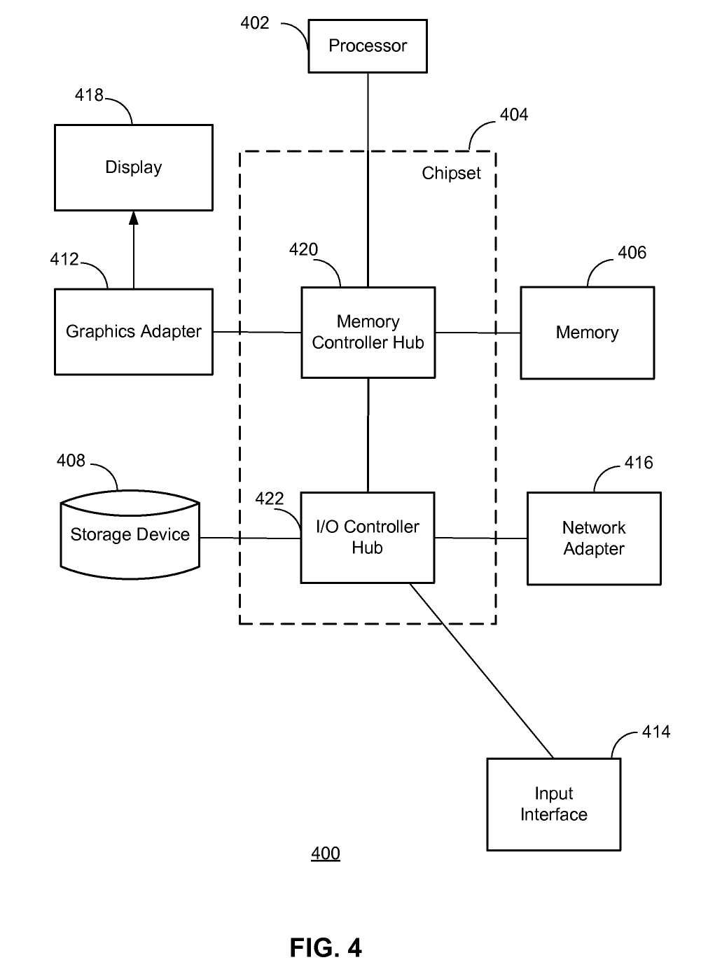

Turning now to a discussion of the implementation of the entities discussed above, FIG. 4 is a high-level block diagram illustrating an example computer 400 for implementing the entities shown in FIG. 1. The computer 400 includes at least one processor 402 coupled to a chipset 404. The chipset 404 includes a memory controller hub 420 and an input/output (I/O) controller hub 422. A memory 406 and a graphics adapter 412 are coupled to the memory controller hub 420, and a display 418 is coupled to the graphics adapter 412. A storage device 408, keyboard 410, pointing device 414, and network adapter 416 are coupled to the I/O controller hub 422. Other embodiments of the computer 400 have different architectures.

The storage device 408 is a non-transitory computer-readable storage medium such as a hard drive, compact disk read-only memory (CD-ROM), DVD, or a solid-state memory device. The memory 406 holds instructions and data used by the processor 402. The input device 414 is a mouse, track ball, some other type of pointing device, a keyboard, a graphical user interface, or some combination thereof, used to input data into the computer 400. The graphics adapter 412 displays images and other information on the display 418. The network adapter 416 couples the computer 400 to one or more computer networks.

The computer 400 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 408, loaded into the memory 406, and executed by the processor 402.

The types of computers 400 used by the entities of FIG. 1 can vary depending upon the embodiment and the processing power required by the entity. For example, the user device 100 may interact with one or more servers working together to provide the functionality described herein. The computers 400 can lack some of the components described above, such as keyboards, graphics adapters 412, and displays 418.

FIG. 5 is a high-level block diagram illustrating a detailed view of modules within the BMP 150 according to one embodiment. The BMP 150 is comprised of modules including a widget module 510, a mapping database 520, an identifier module 530, a mapping module 540, a data grouping module 550, and an analytics module 560. Some embodiments of the BMP 150 have different modules than those described here. Similarly, the functions can be distributed among the modules in a different manner than is described here.

In some embodiments, a widget module 510 creates a widget. As discussed above, the widget is code or instructions (e.g., JAVASCRIPT®, etc.) which when executed by a user device 100 causes the user device 100 to perform certain operations, such as communicating different identifiers associated with the user device 100 (and its associated user) to various entities. For example, the widget causes the user device 100 to retrieve third party identifiers associated with that user device 100 (and its associated user) from third party platforms 140 and provide these third party identifiers to the BMP 150. In alternate embodiments, the widget module 510 retrieves the widget from a stored location. In some embodiments, the widget may have been created by some other entity, the widget module 510, or some combination thereof.

The widget module 510 provides the widget to the vendor 120, such that the widget is associated with vendor content of the vendor 120. Once a widget has been associated with vendor content, a user device 100 requesting the vendor content (e.g., via an app and/or a web page) is also provided the widget. In some embodiments, the user device 100 requesting vendor content associated with the web page is redirected to another web page which provides the widget to the user device 100.

The mapping database 520 stores mappings of BMP identifiers to various third party identifiers. The mapping database 520 stores segment membership data associated with one or more user devices 100. For each user device 100, the mapping database 520 stores an associated BMP identifier, a mapping of a segment to one or more identifiers associated with the user device 100, and one or more parameters associated with the segment. The one or more identifiers include a BMP identifier, and one or more third party identifiers. Additionally, in some embodiments, the mapping database 520 may also store for each user device 100 a user device identifier, a TAS identifier, some other identifier associated with the user device 100, or some combination thereof.

The identifier module 530 creates a BMP identifier for user devices 100. A BMP identifier is a value that uniquely identifies a user device 100 to the BMP 150. The identifier module 530 may base the BMP identifier on identifying information received from the user device 100. For example, the BMP identifier may be generated from a hash of information associated with a user device 100, or a hash of portions of user information (e.g., hash of the user's email address) associated with the user device 100. The identifier module 530 provides a BMP identifier to a requesting user device 100 executing a widget, such that the user device 100 provides the BMP identifier to the TAS 130.

The mapping module 540 maps BMP identifiers associated with respective user devices 100, to one or more third party identifiers associated with the respective user devices 100. The mapping module 540 receives the third party identifiers from the user device 100. Additionally, in some embodiments, the mapping module 540 maps a user device identifier, a TAS identifier, or both, to the BMP identifier. The mapping module 540 provides the mapped identifiers to the mapping database 520.

The mapping module 540 updates segment membership data associated with user devices 100 and their respective users based on the segment membership data received from the TAS 130. The received segment membership data does not contain any mapping to third party identifiers associated with the user devices 100. The mapping module 540 modifies the segment membership data by mapping one or more third party identifiers to their respective user device 100. Additionally, the mapping module 540 updates the mappings of user devices 100 (and their users) to segments based on the received segment membership data.

The mapping module 540 provides portions of the segment membership data and/or updates to the segment membership data to the third party platforms 140. The portions of membership data are provided to the third party platforms 140 using the third party identifiers used by the third party platforms 140.

The data grouping module 550 groups interaction data received from third party platforms 140 by BMP identifier. The data grouping module 550 retrieves from the mapping database 520 a BMP identifier for each third party identifier associated with the received interaction data. The data grouping module 550 groups the interaction data by retrieved BMP identifier, such that each group is associated with a single retrieved BMP identifier.

In some embodiments, the data grouping module 550 requests interaction data from one or more third party platforms 140. In other embodiments, the one or more third party platforms 140 push the interaction data to the data grouping module 550. For example, a third party platform 140 may periodically (e.g., daily, weekly, etc.) push interaction data to the data grouping module 550. Once the interaction data has been grouped, the data grouping module 550 passes the grouped interaction data to the analytics module 560.

The analytics module 560 analyzes the grouped interaction data to produced analyzed data. The analytics module 560 analyzes one or more of the groups of interaction data to extract information that the TAS 130 may utilize to determine if a user's measure of influence (e.g., a lead score) should be adjusted. The analytics module 560 may, for example, determine a number of times the user device 100 interacted with one or more third party platforms 140; determine how frequently the user device 100 interacts (e.g., views an advertisement served by the third party platform 140, clicks on an advertisement served by the third party platform 140, etc.) with the one or more third party platforms 140; determine what the user device 100 interactions were with the one or third party platforms 140; determine some other data relevant to a user's measure of influence, or some combination thereof. The analytics module 560 provides the analyzed data to the TAS 130.

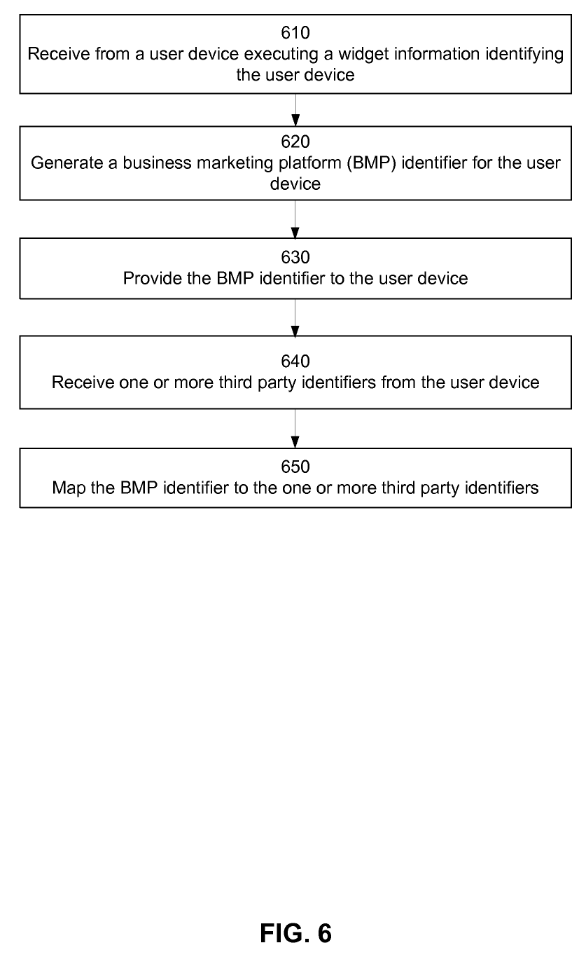

FIG. 6 is a flowchart illustrating a process for mapping a BMP identifier to one or more third party identifiers according to an embodiment. In one embodiment, the process of FIG. 6 is performed by the BMP 150. Other entities may perform some or all of the steps of the process in other embodiments. Likewise, embodiments may include different and/or additional steps, or perform the steps in different orders.

The BMP 150 receives 610, from a user device 100 executing a widget, information identifying the user device 100. For example, the user device 100 may provide a user device identifier to the BMP 150. Responsive to receiving the information identifying the user device 100, the BMP 150 generates 620 a BMP identifier for the user device 100. For example, the BMP 150 may use some of the received identifying information as a BMP identifier associated with the user device 100. Alternatively, the BMP 150 may generate a custom identifier that acts as the BMP identifier using none, some, or all of the received identifying information. The BMP 150 provides 630 the BMP identifier to the user device 100 which is then provided to a TAS 130.

The BMP 150 receives one or more third party identifiers from the user device 100. The third party identifiers are used by different third party platforms 140 to identify the user device 100.

The BMP 150 maps the BMP identifier to the one or more third party identifiers. In some embodiments, the BMP 150 may additionally map other identifiers received from the user device 100 (e.g., at step 610) to the BMP identifier.

FIG. 7 is a flowchart illustrating a process for updating segment membership data according to an embodiment. In one embodiment, the process of FIG. 7 is performed by the BMP platform 150. Other entities may perform some or all of the steps of the process in other embodiments. Likewise, embodiments may include different and/or additional steps, or perform the steps in different orders.

The BMP 150 receives 710 interaction data including a plurality of third party identifiers from a plurality of third party platforms 140. For example, the third party platforms 140 may periodically send interaction data to the BMP 150 describing interactions of user devices 100 with the third party platforms 140.

The BMP 150 aggregates 720 the interaction data using a mapping of a BMP identifier identifying the user device 100 to the plurality of third party identifiers. The mapping may be generated, by for example, the process discussed above with reference to FIG. 6. For example, the BMP 150 may retrieve a BMP identifier for each third party identifier using a mapping stored in a mapping database 520. The BMP 150 then groups the interaction data by the retrieved BMP identifiers. In some embodiments, there may be multiple groups of interaction data associated with the different instances of the same BMP identifier. The BMP 150 groups this data together, such that one BMP identifier is mapped to the multiple groups of interaction data. Accordingly, a group may be associated with a single BMP identifier and be composed of interaction data associated with different third party identifiers.

The BMP 150 analyzes 730 the aggregated interaction data to produce analyzed data. For example, the BMP 150 may determine the number of times a particular advertisement was presented to a user device 100 across all of the one or more third party platforms 140. The BMP 150 provides 740 the analyzed data to a TAS 130. Note, that the TAS 130 is effectively using the third party platforms 140 to promote a vendor 120's product/service to the user device 100. As discussed above with respect to FIGS. 3A-3B, the TAS 130 may update segment membership data for one or more user devices 100 based on the received analyzed data.

The BMP 150 updates 750 a portion of segment membership data in response to receiving an update to the segment membership data from the TAS 130. In some embodiments, the portion of segment membership data may refer to all of the segment membership data. The updates to the segment membership data may be, for example, changing the mapping of one or more user devices 100 to a different segment, a change to one or more parameters associated with a segment, etc.

The BMP 150 identifies 760 one or more third party platforms 140, of the plurality of third party platforms 140, associated with the updated portion of the segment membership data. For example, the BMP 150 may determine third party identifiers associated with the updated portion of the segment membership data using the mapping stored in the mapping database 520. The BMP provides 770 the updated segment membership data to the identified one or more third party platforms 140.

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for automated dictionary generation. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein.

We claim:

1. A system comprising:
one or more processors;
one or more storage media storing instructions which, when executed by the one or more processors, cause:
sending, to a plurality of remote content data sources, executable code to embed in content items that the plurality of remote content data sources provide to client devices.
receiving, over a computer network, from a client device, first interaction data that describes one or more first interactions between the client device and a first content data source of the plurality of remote content data sources, wherein the first interaction data includes an identifier that is associated with the client device;
wherein the client device sends the first interaction data based on executing the executable code that is embedded in a first content item that the client device requested from the first content data source;
after receiving the first interaction data, receiving, over the computer network, from the client device, second interaction data that describes one or more second interactions between the client device and a second content data source, of the plurality of remote content data sources, that is different than the first content data source, wherein the second interaction data includes the identifier that is associated with the client device;
wherein the client device sends the second interaction data based on executing the executable code that is embedded in a second content item that the client device requested from the second content data source;
based on the identifier, associating the first interaction data and the second interaction data with the client device;
after associating the first interaction data and the second interaction data with the client device, aggregating the first interaction data with the second interaction data to generate aggregated interaction data;
performing one or more analysis operations on the aggregated interaction data.
